(19) United States
(12) Patent Application Publication
(10) Pub. No.: US 2011/0214637 A1
(43) Pub. Date: Sep. 8, 2011

(54) AIR INTAKE DEVICE FOR INTERNAL COMBUSTION ENGINES

(75) Inventors: Stéphane Warnery, Rennes (FR); Hervé Douxami, Aron (FR); Jocelin Sechet, Montsurs (FR)

(73) Assignee: MANN+HUMMEL GMBH, Ludwigsburg (DE)

(21) Appl. No.: 13/038,476

(22) Filed: Mar. 2, 2011

(30) Foreign Application Priority Data
Mar. 2, 2010 (FR) 1051507

(51) Int. Cl. F02M 35/10

(52) U.S. Cl. 123/184.56

(57) ABSTRACT

An air intake device for an engine comprises an intake manifold (1) equipped with a series of intake pipes (4) respectively associated with an inlet duct (5) of the cylinder head (3), each of the inlet ducts being subdivided into an upper duct segment (50) and a lower duct segment (51) by a partition (6), and the intake manifold (1) being equipped with a series of flaps (7) mounted about a common rotation shaft (8). The partition (6) of each of the inlet ducts (5) extends into the associated intake pipe (4), and each of the flaps (7) is rotatably moveable between an open position and a sealing position in which each flap (7) essentially seals the lower segment (51) of the associated inlet duct (5).

### CROSS REFERENCE TO RELATED APPLICATIONS

This application claims the benefit under 35 USC 119 of French patent application 1051507 filed in France on Mar. 2, 2010, and which is hereby incorporated by reference in its entirety.

### TECHNICAL FIELD

The present invention relates to an air intake device for an internal combustion engine having a plurality of cylinders.

### BACKGROUND OF THE INVENTION

Such an air intake device classically comprises an intake manifold that is fixed to a flange of the cylinder head of the engine and is equipped with a series of intake pipes respectively associated with an inlet duct of the cylinder head.

Each inlet duct leads into one of the cylinders of the engine so as to enable it to be supplied with air or as applicable with an air/fuel mixture.

It is well-known that in internal combustion engines, it is advantageous to reduce the amount of air supplying the cylinders in low load conditions, particularly upon engine starting, so as to optimize the combustion of the fuel and to reduce emissions of noxious gases.

To this effect, document EP 1 157 200 B1 has already proposed an air intake device of the above-mentioned type wherein the inlet ducts are subdivided into two duct segments by a partition at their interconnection zone with the intake pipes, in which they are essentially parallel.

One of these duct segments or lower segment can thus be shut by a flap that is rotatably moveable about a cross shaft equipping the intake manifold at this interconnection zone, depending on the engine load conditions.

From document DE 20 2007 013 151 U1, an air intake device of the above-mentioned type is also known wherein all the flaps equipping the intake manifold are made of synthetic material and are mounted integral on a common cross rotation shaft realized by shaft segments linking the different flaps, the latter also being made of synthetic material and surrounded by metal sleeves enabling them to rotate in bearings.

However, such a configuration is disadvantageous in that it is not sufficiently rigid, despite being large in size and despite the need to implement drive devices of a relatively large diameter.

### SUMMARY OF THE INVENTION

An objective of the present invention is to provide an air intake device of the above-mentioned type capable of remedying the disadvantages of prior art devices of this kind, and in particular advantageously improving the combustion at low engine loads by reducing pressure drops and by creating gas swirling phenomena in the airflow so as to transfer into the combustion chambers a gaseous mixture that is as homogeneous as possible.

To this effect, the present invention relates to an air intake device for an internal combustion engine in which the intake pipes of the intake manifold and the inlet ducts of the cylinder head are essentially parallel at the interconnection zone, and each of the inlet ducts is subdivided by a partition, at this zone, into two duct segments, i.e. an upper duct segment and a lower duct segment. The partition divides an airflow channel interior to the intake duct into an upper duct segment and a lower duct segment.

The intake manifold is equipped, at the interconnection zone, with a series of flaps each associated with an intake pipe and an inlet duct to seal the lower segment of this duct and mounted about a common rotation shaft extending crosswise in the intake manifold, integral with this shaft.

In various aspects of the invention, such an air intake device is characterized in that:
the partition of each of the inlet ducts extends axially outwardly from the airflow channel of the intake duct into the airflow path of the associated intake pipe of the intake manifold, and
each of the flaps is rotationally moveable between, on the one hand, an open position in which it is housed in a recess or an aperture provided for that purpose on the inner surface of the associated intake pipe, on the lower part of this pipe, so as to unobstructedly open essentially the entire segment of the latter and of the associated inlet duct, and on the other hand a sealing position in which it cooperates with the partition so as to essentially seal the lower segment of the associated inlet duct.

According to an aspect of the invention, the flaps, when in sealing position, may come into contact with the partitions to maintain the sealing at this level such that no air circulates in the lower segment of the inlet ducts.

However, in many cases, it is not desirable to guarantee full sealing at the free end of the partitions in sealing position, and it is instead advantageous to constantly maintain a small passage of air in the lower segment of the inlet ducts.

To this effect, and according to a preferred aspects of the invention, in the sealing position the flaps are positioned to opposite to and closing over the lower duct segment of the inlet ducts while without being in contact with the free end of the partitions. The spacing between the flaps and the free end of the partitions provides a leak slot providing airflow to the lower duct segment even while in the sealing position.

Such a configuration has the advantage of developing swirling and turbulence phenomena in the airflow being sucked or drawn back into the inlet ducts with an additional advantage of reducing airflow pressure drop.

In aspects of the invention the flaps are preferably constituted of elements made of synthetic material produced by molding and each constituted by a central plate forming the flap per se, and by two essentially triangular lateral brackets enabling this central plate to be fixed onto the rotation shaft.

According to another particularly advantageous aspect of the invention, the rotation shaft onto which the flaps are fixed is a continuous metal shaft that is mounted onto bearings made of synthetic material integral with the intake manifold with the shaft extending crosswise essentially to the median part of the intake pipes, opposite the free end of the partitions, and as applicable the leak slots.

Such a configuration wherein the flaps are preferably overmolded onto the metal shaft has the advantage of being very rigid, small in size and of enabling drive devices of a small diameter to be used.

However, the presence of segments of the rotation shaft extending through the intake pipes creates an obstacle to airflow in the intake pipes.

Consequently, for such a configuration to be entirely satisfactory, it is necessary for these segments of the rotation shaft to be as “transparent” as possible to airflow so as to avoid obstructing the airflow and thereby reduce the pressure drop as much as possible.

The positioning of the rotation shaft opposite the free end of the partitions and as applicable the leak slots already enables pressure drops to be reduced.

With this aim, and in accordance with another aspect of the invention, it is further proposed equipping the rotation shaft with flats in line with the intake pipes so as to reduce its section in order to prevent the flow of the drawn in or sucked in air.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 is a longitudinal section of an air intake device according to the preferred embodiment of the invention at the interconnection zone of an intake pipe and an inlet duct; and

FIG. 2 is a perspective view of a rotation shaft bearing a series of flaps.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of apparatus components related to air intake device for an internal combustion engine. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

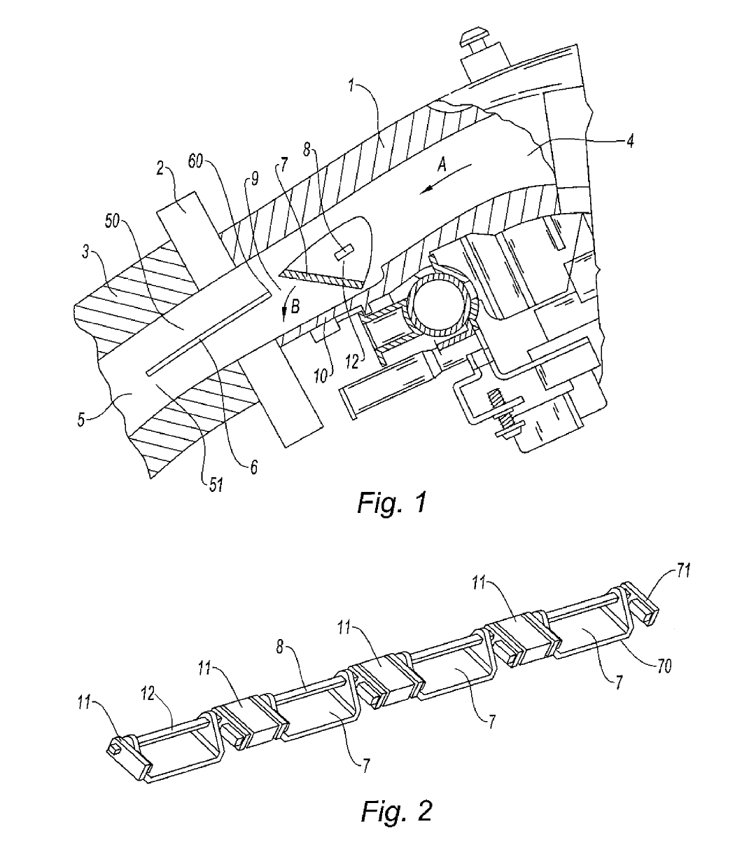

According to FIG. 1, the air intake device comprises an intake manifold 1 fixed to a flange 2 of the cylinder head 3 of the engine.

These elements are very schematically represented in FIG. 1.

The intake manifold 1 comprises a series of intake pipes 4 each associated with an inlet duct 5 of the cylinder head 3 that are all essentially parallel at the interconnection zone.

In the remainder of the description of FIG. 1 herein, reference will only be made to one intake pipe 4 and to the inlet duct 5 associated with this pipe.

It is to be understood that the other intake pipes 4 and the other inlet ducts 5 of the engine have an identical configuration.

According to FIG. 1, the inlet duct 5 of the cylinder head 3 leads into one of the cylinders of the engine which is not represented so as to enable it to be supplied with air sucked into the intake manifold 1 along the arrow A.

At its interconnection zone with the intake pipe 4, the inlet duct 5 is subdivided by a partition 6 into two duct segments having essentially identical sections, i.e. an upper duct segment 50 and a lower duct segment 51.

As shown in FIG. 1, this partition 6 extends into the intake pipe 4 of the intake manifold 1 beyond the flange 2.

The intake pipe 4 of the intake manifold 1 is further equipped with a flap 7 mounted about a rotation shaft 8 integral with this shaft.

This rotation shaft 8 extends crosswise into the intake manifold 1, to the median part of the intake pipe 4, opposite the free end 60 of the partition 6.

The flap 7 is rotationally moveable between a sealing position represented in FIG. 1 and an open position not represented in this Figure.

According to FIG. 1, in sealing position the flap 7 is located opposite the lower duct segment 51 of the inlet duct 5 without being in contact with the partition 6.

A small proportion of the air sucked into the intake pipe 4 along the arrow A can therefore enter the inlet duct 5 segment by a leak slot 9 situated between the flap 7 and the free end 60 of the partition 6.

The upper duct segment 50 of the inlet duct 5 is totally free.

In a manner not represented in FIG. 1, from the sealing position the flap 7 can be moved along the arrow B into an open position in which it is housed in a recess or an aperture 10 provided for that purpose on the inner surface of the intake pipe 4 so as to unobstructedly open essentially the entire segment of this pipe 4 and of the associated inlet duct 5.

According to FIG. 2, the rotation shaft 8 is a continuous metal shaft extending crosswise in the intake manifold 1 to the median part of the intake pipes 4 as represented in FIG. 1.

The flaps 7 are constituted by elements made of synthetic material(s) that are overmolded onto the rotation shaft 8.

These flaps 7 are more precisely constituted by a central plate 70 forming the flap per se and by two essentially triangular lateral brackets 71 enabling the central plate 70 to be fixed onto the rotation shaft 8.

As shown in FIG. 2, the rotation shaft 8 is mounted into bearings 11 made of a synthetic material, integral with the intake manifold 1, which are located between the flaps 7.

The rotation shaft 8 is further equipped with flats 12 which align with the airflow in the intake pipe 4 when the shaft (8) is rotated to the open position so as to reduce pressure drop.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims The invention is defined solely by the appended claims including any amendments made during the pendency of this application and all equivalents of those claims as issued.

1. An air intake device for an internal combustion engine having a plurality of cylinders, said air intake device comprising:
an intake manifold mounted to a flange of a cylinder head of the engine, said air intake manifold including
a plurality of intake pipes (4), each connected for airflow to a respective air inlet duct, each intake pipe communicating airflow to a respective inlet duct of said cylinder head and into a respective one of said cylinders;
wherein each intake pipe of said intake manifold is connected and mounted to its respective inlet duct at an interconnection zone;
wherein each intake pipe and its respective intake duct are substantially parallel at said interconnection zone;
wherein a partition is provided within an airflow channel interior to said inlet duct at said interconnection zone, said partition subdividing said airflow channel of said inlet duct into an upper duct segment and a lower duct segment;
a rotatable shaft extending crosswise in said intake manifold;
a plurality of rotatably movable flaps, each of said flaps in said airflow path within a respective one of said intake pipes, each flap mounted to said shaft for common rotation with said shaft such that said plurality of flaps are rotatably movable and positionable in unison in its respective intake pipe, each flap arranged in or proximate to said interconnection zone;
wherein each of said flaps is rotatably moveable to close over or seal said lower duct segment from airflow in its respective intake pipe;
wherein each intake pipe includes a recess aperture arranged on an inner surface of said intake pipe into which a respective one of said flaps can be rotatably positioned in an open position away from said airflow, unobstructively opening essentially entire airflow path of said intake pipe and entire airflow channel of said intake duct to airflow;
wherein said partition of each inlet duct extends axially outwardly from said airflow channel into said airflow path of its respective intake pipe;
wherein each of said flaps is rotationally moveable and positionable between said open position and a sealing position;
wherein each flap in said sealing position cooperates with its respective partition to close over said lower duct segment, substantially sealing said lower duct segment from airflow.

2. The air intake device according to claim 1, wherein when in said sealing position said flaps are positioned opposite, closing over and spaced apart from said lower duct segments of said inlet ducts without being in contact with a free end of said partitions, said spacing maintaining a leak slot between said flaps and said partitions for airflow to said lower duct section when in said sealing position.

3. The air intake device according to claim 1, wherein said rotatable shaft is a continuous metal shaft rotatably mounted in bearings in said intake manifold and extending substantially crosswise to a median part of said intake pipes, said rotatable shaft positioned spaced apart from said free end of said partitions and, as applicable, said leak slots.

4. The air intake device according to claim 2, wherein
said rotatable shaft is a continuous metal shaft rotatably mounted in bearings in said intake manifold and extending substantially crosswise to a median part of said intake pipes, said rotatable shaft positioned spaced apart from said free end of said partitions and, as applicable, said leak slots.

5. The air inlet device according to claim 3, wherein said rotatable shaft includes flats which align with said airflow in said intake pipes when in said open position, said flats reducing obstruction of said airflow when in said open position to reduce the pressure drop.

6. The air inlet device according to claim 4, wherein said rotatable shaft includes flats which align with said airflow in said intake pipes when in said open position, said flats reducing obstruction of said airflow when in said open position to reduce the pressure drop.
